(19) United States
(12) Patent Application Publication
(10) Pub. No.: US 2011/0229689 A1
(43) Pub. Date: Sep. 22, 2011

(54) Method And Device For Manufacturing A Structured Lining Wave, And Such A Lining Wave

(75) Inventor: Son Ha Giang, Sucy-En-Brie (FR)

(73) Assignee: L'Air Liquide Societe Anonyme Pour L'Etude Et L'Exploitation Des Procedes Georges Claude, Paris (FR)

(21) Appl. No.: 13/131,361

(22) PCT Filed: Dec. 1, 2009
(86) PCT No.: PCT/FR09/52356

§ 371 Date: May 26, 2011

(30) Foreign Application Priority Data
Dec. 4, 2008 (FR) 0858251

(51) Int. Cl. B21D 13/02; B21D 13/10; B01J 19/32

(52) U.S. Cl. 428/141; 72/379.6; 72/385

(57) ABSTRACT

According to this method, a strip is folded and stamped in successive steps by means of two opposing blocks that move alternately toward and away from each other, these blocks having textured active surfaces that are not conjugate with the two surfaces of the corrugation, and the surface of the strip is textured before the folding and stamping are carried out. The invention can be used for air distillation columns.

The present invention relates to a method of manufacturing, from a strip of sheet material which may or may not be perforated, a structured corrugated packing whose general surface is mechanically textured and is generated substantially by moving a repeated profile parallel to the edges of the strip along a line having a principal orientation which is oblique with respect to the edges of the strip and which may or may not be rectilinear over at least part of its length.

It also relates to a corrugated packing manufactured by this method.

Cross-corrugated packings are used in various apparatus, including mixers for a single phase only and devices for heat exchange and/or mass transfer between two fluids. A specific application is to distillation, notably air distillation.

The packing is composed of modules or “packs”, each of which is formed by a stack of strips which are corrugated obliquely in two alternating directions. These strips may or may not be perforated, and are made from smooth or textured sheet, usually made of metal. Examples are described in GB-A-1 004 046 and CA-A-1 095 827.

In the case of distillation columns, the strips lie in vertical general planes. Each module is generally rotated through 90° about the axis of the column with respect to the next module.

A manufacturing method described in FR-A-2820654 uses blocks for folding and stamping the metal strip into a sheet which may or may not be perforated, for a structured corrugated packing.

A variant of this method is currently adopted for producing a packing whose surface is mechanically textured, to produce an embossed surface for example.

Mechanically textured packings are disclosed in U.S. Pat. No. 4,740,334, U.S. Pat. No. 4,981,621, EP-A-0190435, U.S. Pat. No. 4,604,247, U.S. Pat. No. 2,004,135270, EP-A-0807462 and U.S. Pat. No. 4,296,050.

The object of the invention is to enable these corrugations to be produced industrially in a particularly economical way, and, more generally, to permit the production of mechanically textured corrugations with generatrices which have different shapes.

Much of the cost of packing is attributable to the price of the initial material. The base materials used are aluminum, copper, and stainless steel. These metallic materials are becoming increasingly costly over time. A simple solution is to reduce the thickness of the packing. In order to maintain a sufficiently rigid structure while reducing the thickness, the surface of the strip is textured, by embossing for example, thus improving its inertia after folding. Texturing consists in deforming the flat strip with a large number of bosses or hollows which may be have different shapes, including pyramidal, conical, hemispherical and cylindrical. This solution also makes it possible to produce very low-density packing (with a higher corrugation height) while retaining the same strip thickness.

The embossing method can be applied in two different ways.

For this purpose, a method is provided for manufacturing, from a strip of sheet material which may or may not be perforated, a structured corrugated packing having peaks and valleys whose general surface is generated substantially by sweeping a repeated profile along it parallel to the edges of the strip, following a guiding line which has an oblique principal orientation with respect to the edges of the strip and which may or may not be rectilinear over at least a part of its length, in which the strip is folded and stamped in successive steps by means of two opposing blocks that move alternately toward and away from each other, these blocks having surfaces with a generally sinusoidal cross section comprising curved active surfaces, characterized in that the curved active surfaces are linked by concave surfaces in such a way that, when the blocks move toward each other, they come into contact with certain parts of the strip only, preferably the parts which are to form the peaks and valleys of the corrugation, and in that the surface of the strip is textured before the folding and stamping is carried out.

Preferably:
the active surfaces are concave;
at least one of the blocks comprises at least one textured surface for imparting a texture to the strip;
the strip is perforated before the folding and stamping are carried out, and preferably before the surface is textured, if this is not done at the same time as the folding and stamping;
the corrugation is a cross-corrugated packing.

The invention also proposes a device for using this method, comprising two opposing folding and stamping blocks whose generatrices may or may not have at least one non-rectilinear part, means for giving these blocks an alternating relative movement toward and away from each other, and means for making a strip of sheet material advance in successive steps between the blocks when the blocks are in an open position and means for perforating the strip and/or surface texturing means located upstream of the blocks.

According to another aspect of the invention, a cross-corrugated packing is provided, having a plurality of stacked corrugated lamellae, the plates being substantially identical but oriented in such a way that the adjacent plate corrugations cross each other, at least some of the plates having texturing characterized in that the plates having texturing are substantially smooth on the inside and/or the outside of each peak line and/or each valley line and have texturing in at least a part of the sides of each plate located between a peak line and a valley line, manufactured by the method as claimed in one of claims 1 to 5.

Generally, the peaks are not completely smooth, if they have previously been textured, because some embossing marks remain.

Preferably, the part of the plate having a smooth surface (or substantially smooth, for example with flattened texturing) represents 20% to 50% of the plate, the remaining 50% to 80% of the plate being textured.

Preferably, the smooth part is formed by strips surrounding the peak and valley lines of the corrugation.

Examples of embodiment of the invention will now be described with reference to the attached drawings, in which:

FIG. 1 shows a corrugation formed according to the invention, viewed from the side;

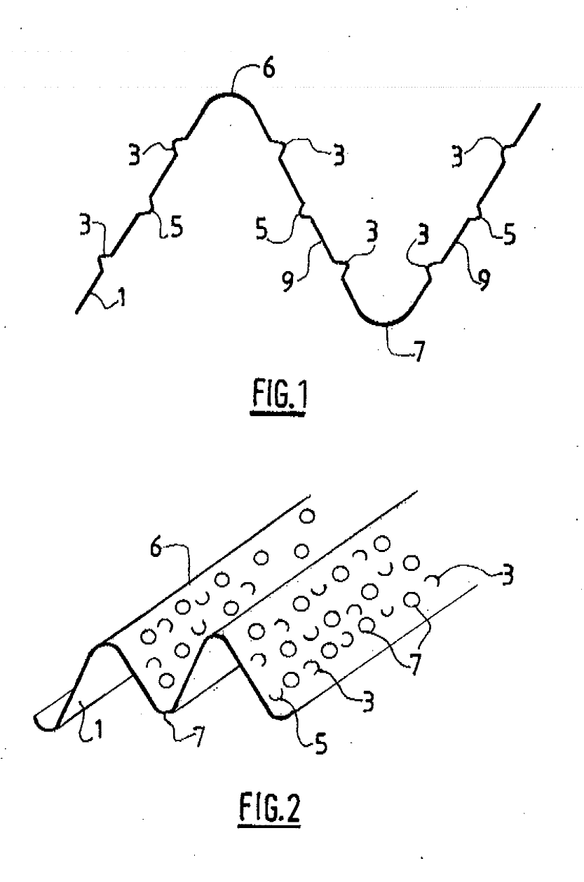

FIG. 2 is a perspective view of a corrugation formed according to the invention;

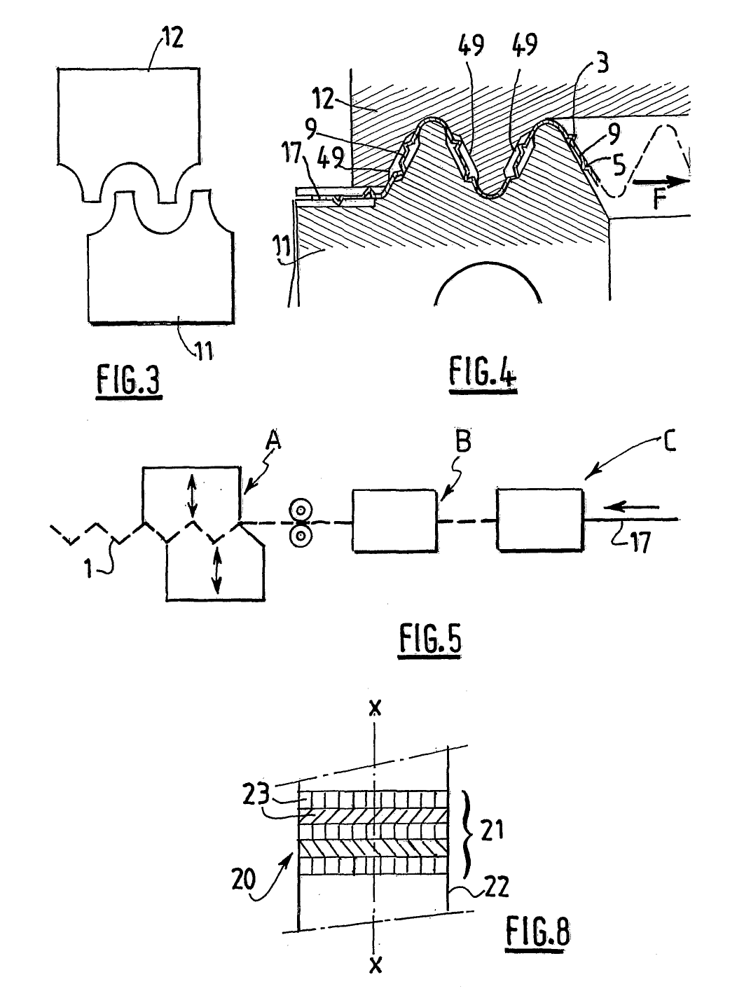

FIG. 3 shows a section through two folding and stamping blocks for manufacturing this corrugation;

FIG. 4 is a sectional view of the corrugation in the course of manufacture;

FIG. 5 is a schematic view of another variant of the method of the invention;

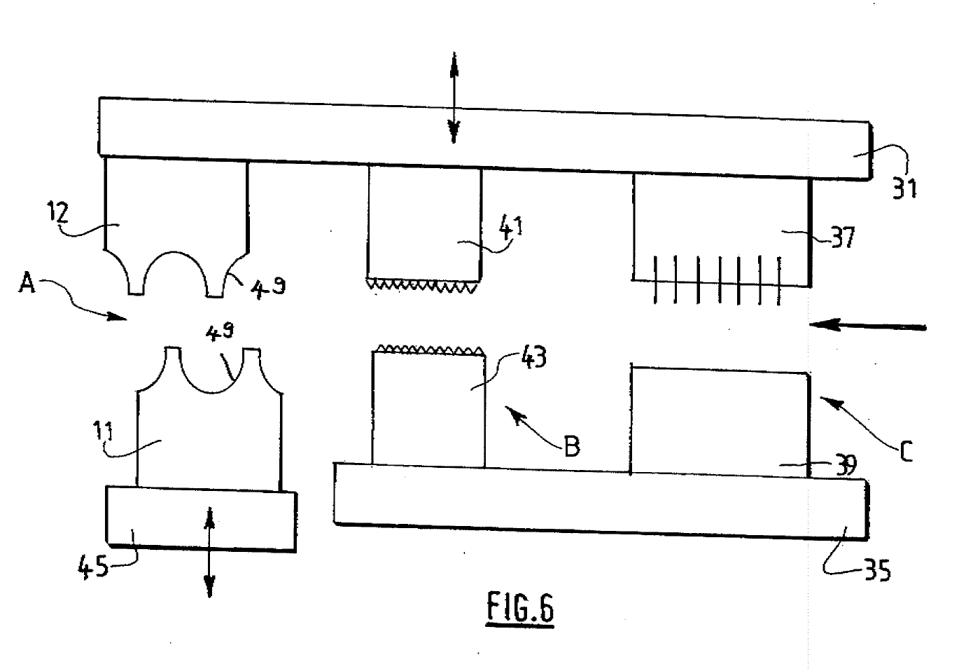

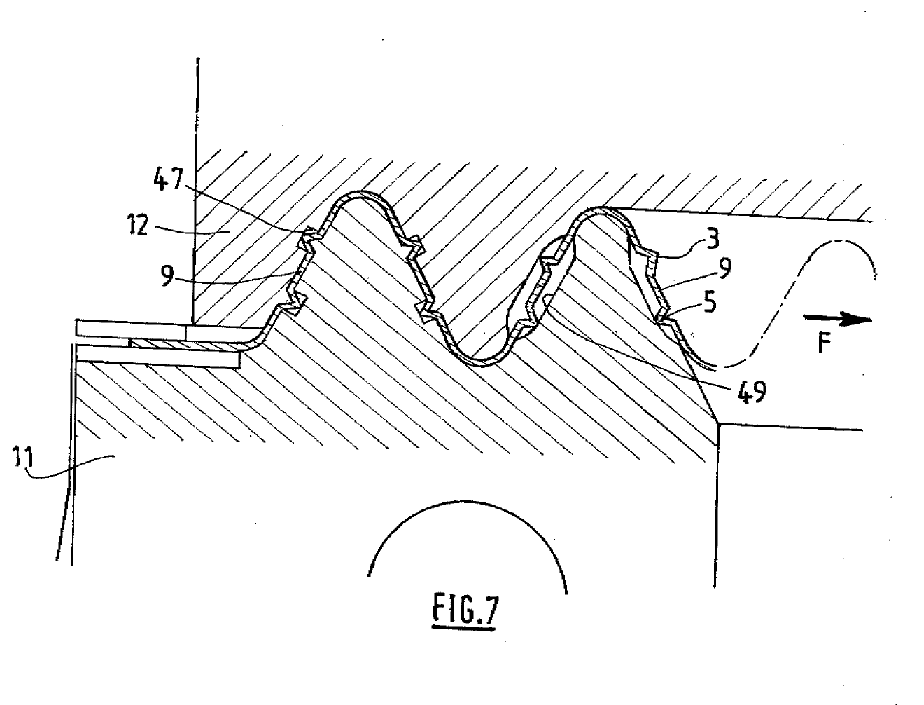

FIG. 6 shows in more detail the method steps of FIG. 5; and

FIG. 7 is a schematic view of part of an air distillation column according to the invention.

The corrugation 1 shown in side view in FIG. 1 is a thin metal sheet folded to form regular corrugations. The repeated profile of the corrugation 1 is in the form of a zigzag with curved sides 9, having upper peaks 6 and lower peaks 7 with the smallest possible radii.

Bosses 3 and hollows 5 are formed at least in the slopes of the corrugation, the shape of the bosses and hollows being identical in such a way that a boss 3 viewed from one side of the strip becomes a hollow when viewed from the other side of the strip.

The corrugation 1 is made from a thin flat metal strip by simple folding and stamping, using a device A comprising two opposing blocks, namely a lower block 11 and an upper block 12, which move alternately toward and away from each other.

Each block has two teeth projecting toward the other block, identified by the numbers 13-14 and 15-16 respectively, all the teeth having the same height. The teeth are linked by concave surfaces and are arranged so as to interpenetrate.

The packing can be textured over its whole surface or can be textured only on certain parts of the surface, for example only on the slopes of the corrugation. In this second case, texturing is carried out initially, for example in the form of embossing on the whole surface of the strip, after which the flat strip is folded and stamped using a lower and an upper shaping block. At the peaks and valleys, the texturing is reduced or even eliminated: for example, in the case of embossing, the points or hollows are flattened during the folding and stamping of the corrugation. This form of texturing, in which the peaks of the corrugation are not textured, allows a regular constant contact to be provided between the strips. This provides a more regular and uniform distribution of liquid.

If this “roughness” in the peak folds is eliminated, the liquid will not be excessively perturbed at the peaks of the cross-corrugated packing: this limits the risks of break-away or entrainment of droplets by the gas flowing over the packing in countercurrent.

The elimination of this texturing in the hollows also prevents excessive accumulation of liquid in the “dead” areas, in other words in places where there is little contact with the gas (the phenomenon of capillarity).

A possible improvement of the invention relates to the orientation and arrangement of this texturing on the plate. It is known that the natural flow of a liquid on a plate follows the line of the greatest gradient (described in WO-A-0304148). If it is desirable to create perturbation of the liquid film flowing over the plate, it is useful to be able to arrange or align these local deformations of the plate in a suitable way, as follows:
in the case of fluting, the lines should be perpendicular to the line of the greatest gradient;
in the case of local deformations such as bosses and the like, these should be arranged in such a way that there is an alignment perpendicular to the line of the greatest gradient.

The density of the texturing is from 5% to 30% of the total surface of the flat strip.

The height of the bosses or hollows of the embossing varies from 0.3 to 1.5 mm, for corrugations with a height of 3 to 12 mm.

FIG. 3 shows cross sections of the blocks 11, 12 of the folding and stamping apparatus. By contrast with the prior art, these have no straight edges, but each has an edge with a cross section which is at least substantially sinusoidal, the teeth of these edges interpenetrating.

As shown schematically in FIG. 4, the previously embossed initial strip 17 is advanced in steps in the direction of the arrow F, parallel to these edges, by means of an advance mechanism, while the blocks are spaced apart from each other, the step of advance being equal to the pitch of the corrugation. After each advance, the blocks are brought toward each other and deform the metal, which does not fill the whole space between the blocks, since the metal which is to form the slopes of the corrugation is separated from the teeth by the concavities 49. Only the peaks of the corrugation are in contact with the teeth.

Thus the texturing of the peaks is flattened by the teeth. Alternatively, it is possible to arrange for the embossing to be done in such a way that the areas of metal which are to form the peaks are not embossed.

As is known, the strip 17 can be perforated before being folded, either in a separate perforation station located upstream of the device A, or at the position of this device.

The corrugation 1 can then have a height which is slightly reduced near its edges, which does not give rise to any particular disadvantages in the resulting packing modules. According to the invention, the folding, forming and stamping after punching is carried out with a single tool. FIG. 5. In this case, the folding, forming and stamping tool will have bosses and hollows on the sides of the profile.

Thus the corrugation is manufactured rapidly, economically and reliably with this type of block.

The variant of FIG. 5 shows the case in which the texturing of the structure is carried out upstream of the folding.

For this purpose a station B is provided for texturing the surface of the metal strip upstream of the folding and stamping station A. This variant can be applied more specifically to perforated corrugations. In this case, as illustrated, the station B is located between a perforation station C and the folding and stamping station A. A metal annealing station (not shown) can be located between the stations B and C or between the stations A and B.

Clearly, the invention enables corrugated packings to be made with corrugations of widely varying forms from embossed sheets, and in this way the properties of the resulting cross-corrugated packings can be improved.

FIG. 6 shows the perforation station C which has needles for creating the perforations, the embossing station B, and the folding and stamping station.

As shown schematically in FIG. 6, there is a second way of forming the embossed corrugations. In this case, the unembossed initial strip 17 is advanced in steps in the direction of the arrow F, parallel to these edges, by means of an advance mechanism, while the blocks 11, 12 are spaced apart from each other, the step of advance being equal to the pitch of the corrugation. After each advance, the blocks are brought toward each other and deform the metal. The first teeth comprise openings (not shown) into which the metal is forced by the movement of the press, in order to form the bosses and hollows of the embossing. At least one upper or lower tooth of the block must have openings, but preferably the upper and lower teeth comprise them. The second teeth are formed in the same way as those of FIG. 4, with concavities 49. Thus the metal of the strip does not fill the whole of the space separating the blocks, since the metal which is to form the slopes of the corrugation is separated from the teeth by the concavities 49. Only the peaks of the corrugation are in contact with the teeth.

A possible improvement of the invention relates to the orientation and arrangement of this texturing on the plate. It is known that the natural flow of a liquid on a plate follows the line of the greatest gradient (described in WO-A-0304148). If it is desirable to create perturbation of the liquid film flowing over the plate, it is useful to be able to arrange or align these local deformations of the plate in a suitable way, as follows:
in the case of fluting, the lines should be perpendicular to the line of the greatest gradient;
in the case of local deformations (bosses, for example), these should be arranged in such a way that there is an alignment perpendicular to the line of the greatest gradient.

FIG. 7 shows part of an air distillation column 20, comprising a distillation section 21 placed in the cylindrical shell 22 of the column. The section 21 is formed by a cross-corrugated packing which is itself formed by a stack of packing modules 23. Each module 23 is formed by a stack of corrugations 1, each located in a general vertical plane, cut to length from the folded strip 17 and having the general directions of corrugation inverted between one corrugation and the next, the edges being positioned horizontally. Each module 22 is rotated through 90° with respect to the next module about the vertical axis X-X of the column.

1-7. (canceled)

8. A method of manufacturing, from a strip of sheet material which may or may not be perforated, a structured corrugated packing having peaks and corrugations whose general surface is generated substantially by sweeping a repeated profile along it parallel to the edges of the strip, following a guiding line which has an oblique principal orientation with respect to the edges of the strip and which may or may not be rectilinear over at least a part of its length, in which the strip is folded and stamped in successive steps by means of two opposing blocks that move alternately toward and away from each other, these blocks having surfaces with a generally sinusoidal cross section comprising curved active surfaces, wherein the curved active surfaces are linked by concave surfaces in such a way that, when the blocks move toward each other, they come into contact with certain parts of the strip only, and in that the surface of the strip (17) is textured before the folding and stamping is carried out.

9. The method of claim 8, wherein the curved active surfaces are linked by concave surfaces in such a way that, when the blocks move toward each other, they come into contact with the parts which are to form the peaks and valleys of the corrugation.

10. The method of claim 8, in which the active surfaces are concave.

11. The method of claim 8, in which at least one of the blocks comprises at least one textured surface for imparting texturing to the strip.

12. The method of claim 8, wherein the strip is perforated before the folding and stamping are carried out.

13. The method of claim 12, wherein the strip is perforated before the surface is textured, if this is not done at the same time as the folding and stamping.

14. The method of claim 8, wherein the corrugation is a cross-corrugated packing.

15. A device for using the method of claim 8, comprising two opposing folding and stamping blocks whose generatrices may or may not have at least one non-rectilinear part, means for giving these blocks an alternating relative movement toward and away from each other, and means for making a strip of sheet material advance in successive steps between the blocks when the blocks are in an open position, and means for perforating the strip and/or surface texturing means located upstream of the blocks.

16. A corrugated packing of the cross-corrugated type, comprising a plurality of stacked corrugated plates, the plates being substantially identical but oriented in such a way that the corrugations of adjacent plates cross each other, at least some of the plates having texturing, wherein the plates having texturing are substantially smooth on the inside and/or the outside of each peak line and/or each valley line and have texturing on at least part of the slopes of the plate located between peak line and a valley line, and in that the corrugation is manufactured as claimed in claim 8.
